(19) United States
(12) Patent Application Publication
(10) Pub. No.: US 2024/0046266 A1
(43) Pub. Date: Feb. 8, 2024

(54) SYSTEMS AND METHODS FOR CRYPTOGRAPHIC CONTEXT-SWITCHING AUTHENTICATION BETWEEN WEBSITE AND MOBILE DEVICE

(71) Applicant: Capital One Services, LLC, McLean, VA (US)

(72) Inventors: Jeffrey RULE, Chevy Chase, MD (US); Stephane LUNATI, Boerne, TX (US); Kaitlin NEWMAN, Washington, DC (US)

(21) Appl. No.: 17/883,232

(22) Filed: Aug. 8, 2022

(51) Int. Cl. G06Q 20/40; G06Q 20/32; H04L 9/40

(52) U.S. Cl. CPC G06Q 20/401; G06Q 20/3278; G06Q 20/409; H04L 63/0421; G06Q 2220/00

(57) ABSTRACT

Systems and methods for implementing an automated system and process for facilitating a streamlined and secure transfer of authenticated user data over a network. The process may be initiated via activation of a customized hyperlink displayed on a web interface. The customized hyperlink being operationally integrated with an encryption and authentication providing system to trigger one or more data collection and/or authentication operations that enable an automated retrieval of authenticated user information in a secure fashion. One aspect of the security involves an authentication scheme facilitated by context-switching between a mobile browser-initiated http/https session and one or more data collection and/or authentication functionalities provided by one or more applications stored on a user mobile device. The secure data retrieval process may be further supplemented by a cryptographic exchange of request and/or response messages enabled by a back-end integration with the encryption and authentication providing system.

### FIELD OF THE DISCLOSURE

The present disclosure relates to systems and methods for providing authentication credential and authenticated user information over a network, and more specifically to a system and method for providing cryptographic context-switching based authentication.

### BACKGROUND

A streamlined and secure network transport of authenticated user-related data, from systems and applications storing sensitive data resources to systems and applications requesting authenticated sensitive user data remains a major challenge, particularly, for secure and efficient implementation electronic transactions. Several routines for providing secure access to sensitive and/or private information have been devised for authenticating a source of information prior to retrieval and transport of the said sensitive and/or private information. However, in many instances, involving an exchange of user Private Identification Information (PII) and/or Payment Credential Information (PCI), the verification process is reliant upon manual entry of a user PII and PCI directly onto an electronic form provided by a merchant system prior to initiating a user-requested transaction. In such cases, the user will manually enter several pieces of information that will then be verified against pre-validated user information (e.g., as stored by a corresponding financial institution). This implementation is cumbersome and prone to human error as it necessitates the collection and the manual entry of the required data by the user into an electronic form. These and other deficiencies exists.

### SUMMARY OF THE DISCLOSURE

One aspect of the present disclosure is directed to an automated process for facilitating a streamlined and secure transfer and/or retrieval of authenticated user-related information over a network. The process may be initiated via activation of a customized hyperlink displayed on a web interface (such as a payment checkout screen). The customized hyperlink displayed, for example, on a payment checkout screen of a merchant website, may be operationally integrated, on the back-end, with an external encryption and authentication providing system and process to trigger one or more data collection and/or authentication operations which facilitate the authenticated retrieval of sensitive user information in a secure fashion.

One aspect of the security feature associated with the aforementioned system and process involves an authentication scheme facilitated via context-switching between a (mobile) browser-initiated HTTP and/or HTTPS session (e.g., initiated from a mobile device via standard web access across the Internet) and one or more data collection and/or authentication functionalities provided by one or more applications stored on a corresponding user mobile device. The context-switching authentication scheme thus enables a streamlined and secure retrieval of an authorization response from an authenticated user, prior to initiating the transfer of the requested (sensitive) user information to a requesting merchant system and/or server (e.g., the server and/or device that initiated the request for sensitive user data.) The secure user-data retrieval process may be further supplemented by a cryptographic exchange of request and/or response messages enabled by a back-end integration of the transacting (merchant) website with the external encryption and authentication providing system and process.

In some embodiments, one or more applications, stored on the user mobile device, may initiate the collection and authentication of the requested (sensitive) user data (e.g., user PII and/or PCI data.) The one or more applications (e.g., associated with data collection and authentication operations) may be invoked in accordance to one or more instructions encoded in a universal link. The universal link may be generated and transmitted to the mobile user device in response to a request for sensitive user data originating from a remote merchant system and/or server. The user-data request message may be generated by the remote merchant system upon activation of a custom link (e.g., the customized hyperlink) incorporated onto on a payment processing web interface of the merchant system (e.g., a user clicking the custom link for completing an online transaction initiated via an a mobile browser session.) The request message may then be transmitted to an authentication server (associated with the external encryption and authentication providing system and process) and communicated, therefrom, to the user mobile device in form of a universal link generated, for example, by the authentication server.

The universal link may comprises one or more instructions to prompt one or more authentication inputs to be provided using the mobile user device. The one or more authentication inputs captured by the user mobile device may then be sent back to the corresponding authentication server for validation. Once validated, the requested sensitive user data (in accordance to an authorization from an authenticated user) may be communicated to the (transacting) merchant system and/or server, via an encrypted back-end communication link (e.g., implemented via a back-end integration of the merchant system with the authentication and encryption providing system and process). The requested (authenticated) user data, may then be auto-populated onto an electronic transaction form provided, by the merchant system, as part of an online payment interface for facilitating an online payment transaction.

The universal link may correspond to a universal resource indicator (URI) (e.g., a hyperlink, universal resource locator (URL), or other data resource indicators) and may further comprise components for identifying a target destination (e.g., web server administering the merchant website where the request came from) and the specific user transaction session to which the data, corresponding to user PII and/or PCI, is to be applied. The URI may further comprise a deep link to an authentication functionality available on the mobile user device. The authentication functionality may be provided by an authentication application stored on the user mobile device. The authentication application, upon being invoked in accordance to instruction encoded in the deep link, may initiate retrieval of one or more authentication inputs via the mobile user device to validate the request for, and subsequent transmission of, the sensitive user data to the merchant system for facilitating the specific user transaction session.

Accordingly, the secure sensitive-data retrieval process may comprise: providing a custom link at an interface of a website, wherein the website is integrated with an authentication feature provided by an external authentication system (e.g., external to the transaction initiating web server); generating, in response to a user selection of the custom link, a universal link, the universal link comprising: a website identifier identifying the website where the custom link is activated by the user selection; a unique anonymous user identifier, the unique anonymous user identifier being generated by the website to track a particular user session; an identifier for an authentication application for implementing the context-switching authentication scheme, the authentication applications being associated with the external authentication system and, stored on a user device from which the website is accessed; transmitting the universal link to the user device, wherein the universal link launches the authentication application prompting the user for one or more authentication actions and/or inputs; transmitting, by the user device, the one or more authentication inputs to the corresponding authentication server for validation; and upon validation of the one or more authentication inputs, transmitting, one or more requested user data to be auto-populated on the interface of the website.

In accordance to some embodiment of the present disclosure, user authentication information (e.g., the one or more authentication inputs associated with the context-switching authentication scheme) required for authenticating a user's authorization response, may be provided by a contactless card with integrated processor and memory storing user identifying and/or authenticating information as near field communication (NFC) transmittable data (e.g., NFC Data Exchange Format (NDEF)). The user authentication information may then be directly captured by a reader component of the mobile user device and transmitted to the authentication server for validation. As such, the one or more authentication inputs may be provided by a single user action of bringing the contactless card within an NFC range of the mobile device (e.g., by tapping the contactless card on a reader of the user mobile device) to initiate a direct read and subsequent validation of user authentication information stored, as NFC transmittable data, on the contactless card.

In some embodiments, one or more data record corresponding to sensitive user data (e.g., user PII and/or PCI data) may be directly stored, as NFC transmittable data, on an integrated memory of the contactless card. In response to a request for sensitive user information, the one or more data records may then be read from the contactless card (as initiated by the authentication application) using the user mobile device running a corresponding reader application and directly sent to the remote merchant server to be auto-populated on the appropriate payment screen. In some embodiments, the requested user data read from the contactless card by a reader device incorporated in the user mobile device, may be transmitted, by the user mobile device, to the authentication server for validation. Upon successful validation, the user information (securely retrieved directly from the contactless card) may then be sent to the requesting (merchant) server.

In some embodiments, network communication messages between the merchant server and the authentication server may be communicate via an encrypted communication link facilitated by a back-end integration between the (remote) merchant server and the encryption and authentication providing system and process). In some embodiments, the secure user-data retrieval process may occur over a public network using a public and/or private encryption process.

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates an exemplary system implementation for authenticated data transfer using context-switching authentication with cryptographic back-end integration, based on user-inputted credentials, in accordance to some embodiments of the present disclosure.

FIG. 2 illustrates an exemplary system implementation for authenticated data transfer using context-switching authentication with cryptographic back-end integration, using NFC-transferred credentials from a contactless card, in accordance to some embodiments of the present disclosure.

FIG. 3 illustrates an exemplary system implementation for authenticated data transfer using context-switching between a website and an NFC-enabled contactless card, in accordance to some embodiments of the present disclosure.

FIG. 4A illustrates a contactless card in accordance to some embodiments of the present disclosure.

FIG. 4B illustrates a contact pad of a contactless card in accordance to some embodiments of the present disclosure.

FIG. 5 illustrates an operational flowchart of an exemplary context-switching authentication process between a website and mobile application based on user-inputted credentials, in accordance to some embodiments of the present disclosure.

FIG. 6 illustrates a timing sequence diagram for auto populating an electronic form with authenticated data transmitted from an NFC-enabled contactless card, in accordance to some embodiments of the present disclosure.

FIG. 7 is an illustration of an exemplary block diagram of an exemplary system, in accordance to some embodiments of the present disclosure.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Some embodiments of the present disclosure are directed to an encryption and authentication providing system and process implemented by configuring a secure back-end encryption system with a context-switching authentications scheme in such a way so as to enable a direct and secure transfer and/or retrieval of sensitive data resources (e.g., user PII and/or PCI) over a public network, such as the Internet. In some embodiment, an encrypted exchange of request and response messages between a requesting merchant system and the encryption and authentication system may be implemented via a back-end integration of the merchant website with the externally-provided encryption and authentication system and process.

The process, in accordance to the aforementioned embodiment, maybe dynamically triggered upon activation of a custom (checkout) link (e.g., an actionable button and/or icon) presented at a web interface (e.g., a payment checkout screen) of a transacting (merchant) server. The custom link being associated with a back-end integration of the transacting merchant website with an external encryption system configured with a context-switching authentication functionality, which is initiated upon activation of the custom link. The external encryption system configured with a context-switching authentication functionality, may refer to an a system and/or process that is externally implemented with respect to the transacting merchant system, but provides a functionality accessible, by the merchant system, via the back-end integration with service-providing system. Accordingly, for the purposes of the present disclosure, the encryption and authentication providing system may interchangeably be referred to as an “external encryption and authentication system” and/or “external authentication system.”

As described, the aforementioned functionality (corresponding to encrypted and authenticated transfer and/or retrieval of sensitive user data) may be accessed upon activation of a custom checkout link presented, for example, at a payment checkout screen of the merchant website. In some embodiments, in addition to the activation of the custom link, a user may be requested to input some initial identifying information, such as an email address, in order for the request for the secure data transfer process to be generated. The initial user identifying information may then be transmitted, along with a request for sensitive user information (e.g., user PII and PCI), to an authentication server (associated with the backend integration). The initial user identifying information may be used, by the receiving (authentication) server, as a search index to identify and collect the relevant and/or requested user information. In some embodiments the receiving (authentication) server, may use the initial user identifying information to determine a device identifier associated, for example, with a user mobile device, along with one or more application identifiers corresponding to one or more data-collection and/or authentication applications stored on the user mobile device.

The set of identifiers associated with the user mobile device and the corresponding mobile applications, may be incorporated into a Universal Resource Indicator (URI), such as a universal link, a universal resource locator (URL), or other indicator, generated by a URI generating processes running, for example, on the receiving (authentication) server. According to some embodiments, the URI generating processes may be running on the authentication server. N some embodiments, the URI generating processes maybe running on a remotely-located URI generating server communicatively coupled to the authentication server. The URI generating process may integrate, into the generated universal link, the one or more mobile application identifiers corresponding to one or more data-collection and/or authentication applications stored on the user mobile device. The generated universal link may then be transmitted to a user device (as identified by the user mobile device identifier.) The universal link may further comprise instruction to launch the identified mobile application(s) on the user mobile device to facilitate the context-switching authentication of the request and/or the retrieval of sensitive user information.

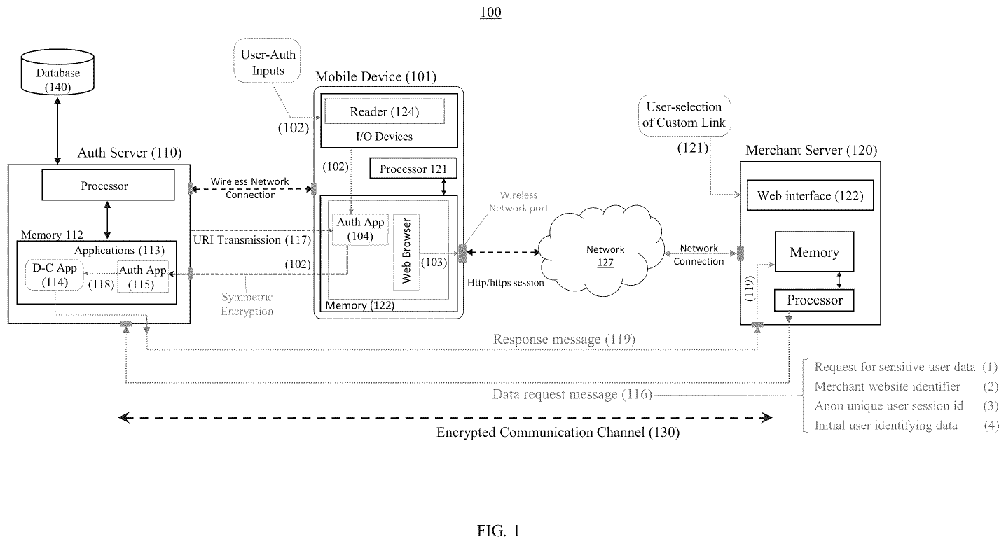

FIG. 1 illustrates an exemplary encryption and authentication providing system (100) (interchangeably referred to as the “authentication system” (100) for the purpose of the present disclosure) for a implementing an authorized transfer of sensitive user data, validated based on one or more user authentication inputs provided for authorizing the transfer. With reference to FIG. 1, the acquisition of one or more user authentications inputs (102) may be enabled by context-switching between a mobile browser session (103) initiated from a user mobile device (101), and an authentication application (104) stored on the user mobile device (101). The one or more user authentications inputs may then be transmitted, by the user mobile device (101) to an authentication server (110) for validation. Upon validation of the one or more authentication inputs provided in connection with a data-transfer authorization response, the requested sensitive user information may be transmitted to a remote destination server (e.g., merchant server 120) via an encrypted back-end communication channel (130) (e.g., implemented via a back-end integration of the merchant server (120) with the authentication and encryption providing system and process (100).

The authentication server (110) may comprise one or more server-side applications (113) corresponding, for example, to a Data Collection application (114) and/or an authentication application (115). The authentication server may be communicatively coupled with a user device (e.g., mobile device 101) and responsive to one or more communications from one or more (client-side) applications (e.g., authentication application 104) stored on the user mobile device (101). The authentication server (110) may further be communicatively coupled with a plurality of remote merchant systems via a back-end integration of the aforementioned remote merchant systems with the authentication system (100). As discussed above, the authentication process may be based on context-switching between a browser session (103), initiated by a web browser running on the user mobile device 101, and an authentication functionality provided by the external authentication system 100. The Authentication server (110) may also be connected to a database (e.g., database 140) which may be used for storing one or more user Personal Identification Information (PII) and/or Payment Credential Information (PCI) for a plurality of users. Although FIG. 1 illustrates single instances of the components, the system 100 may include any number of components.

Referring back to FIG. 1, the context-switching authentication process may be initiated by a universal link transmission (117) to a user mobile device (101). The universal link (118) may be generated by the authentication server (110) in response to a data request message (116) received from a remote merchant server (120). The data request message (116) may correspond to a request for sensitive user data (1) triggered by a user selection of a custom link (121) at a web interface (122) of a transacting merchant server (120). The requested sensitive user data may correspond to one or more user data records required, for example, to process a payment transaction at a web interface of a merchant website. In addition to the request for sensitive user data (1), the data request message (116) may further include a merchant website identifier (2), an anonymous unique user session identifier (3) (for identifying the specific user transaction session on the merchant website), and an initial user identifying information (4) (e.g., an email address provided by the user at web interface 122 of merchant server 120). The data request (116) may then be transmitted to the authentication server (110) over the back-end encrypted communication link (130). In response, the authentication server (110) initiates a context-switching (authentication) scheme to map the data request for sensitive user information with an authorization response from an authenticated user (e.g., based on validating one or more user authentication inputs 102) prior to authorizing the transmission of the requested sensitive user data to the remote merchant server.

As described earlier, the context-switching (authentication) scheme may be initiated by a universal link transmission (117) to the user mobile device (101). The universal (link) may comprise an application identifier for identifying a target application (e.g., authentication application 104) stored on the user mobile device (102), and coded instruction for invoking the target (authentication) application. The authentication application (104), upon being invoked in accordance to one or more instruction encoded in the universal link, may initiate retrieval of one or more authentication inputs (102) via the user mobile device (101). The one or more authentication inputs (102) captured by the user mobile device (101) may then be sent back to the corresponding authentication application and/or process (115) for validation. Once validated, an authentication signal (118) may trigger a data collection application and/or process (114) to retrieve, and transmit the requested sensitive user data via a response message (119) to the remote merchant server (120). The response message may be sent to the merchant system/server via an encrypted back-end communication link (130) implemented via a back-end integration of the merchant server (120) with the authentication system 100. The specific user transaction session may then be identified (e.g. based on the anonymous unique user session identifier (3) included in response message 119), and the requested user data (e.g., user PII and/or PCI) auto-populated onto an electronic transaction form provided, by the merchant server, as part of an online payment interface, enabled via a back-end integration with the authentication system 100. User PCI data may correspond to a primary account number (PAN) and/or a credit/debit card data. In some embodiments a merchant-specific Virtual Credit Card Number (VCN) may be generated in response to a data request message (116) and subsequently provided as user PCI data in the response message (119).

Encrypted network communications exchanged between the remote merchant server (120) and the authentication server (110) may occur via an encrypted back-end communication link (130). The encrypted network communications may correspond to the data request message (116) from the remote merchant server (120) and subsequent transmission of the response message (119) by the authentication server (110). In some embodiment the aforementioned communication may take place across a public network using public/private encryption routines. In some embodiment the communication between a merchant server and the authentication server may be implemented with a shared secret encryption scheme.

In some embodiments the target application, associated with the application identifier encoded in the universal link, may correspond to a data-collection application integrated with an authentication functionality that is provided by the external authentication system. In some embodiments, the data-collection application may be operationally coupled with a distinct authentication application separately stored on the user device (101). The data-collection application may collect the user PII and PCI information (that may be stored in parts or in full on one or more of the user mobile device (101), a corresponding authentication server (110) and/or one or more external/internal data repositories (e.g., database 140)), and upon confirming (via an authentication confirmation signal (118) from the authentication applications) the validity of the request for sensitive user information, transmitting the sensitive user information to the merchant website for auto-population onto a payment checkout screen. The authentication confirmation signal (118) may correspond to an authorization response from an authenticated user.

In some embodiments an authentication scheme used for authenticating a user authorization response for the transfer of sensitive user data to a remote entity, may correspond to confirming that the user authorizing the transfer of sensitive user information is in possession or proximity of a verifiable device associated with a transacting user (e.g., the user initiating the transaction by clicking on the custom checkout link provided at the payment screen of the merchant website). A verifiable user device may be provided in form a contactless card with integrated processor and memory storing user identifying/authenticating information as near field communication (NFC) transmittable data.

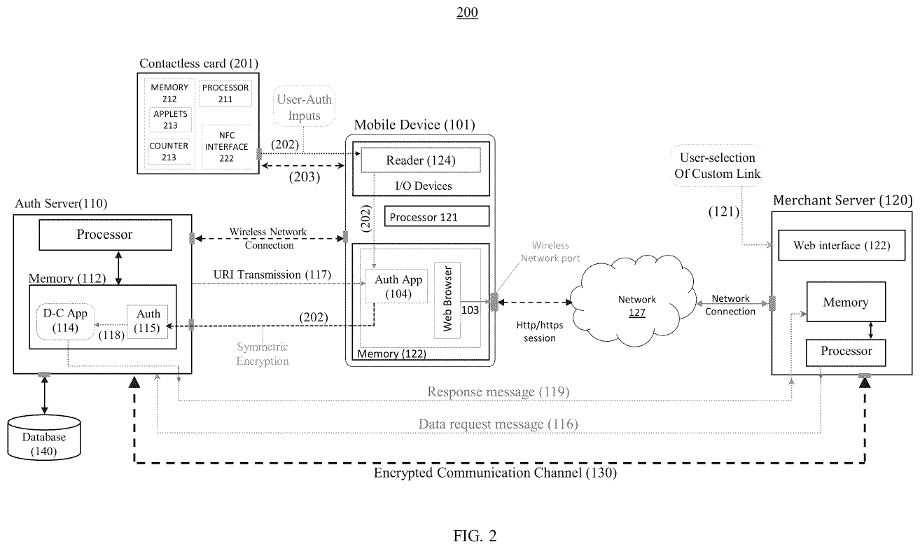

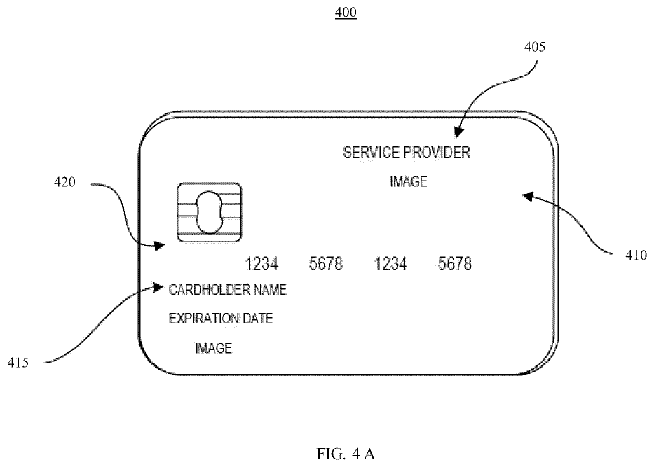

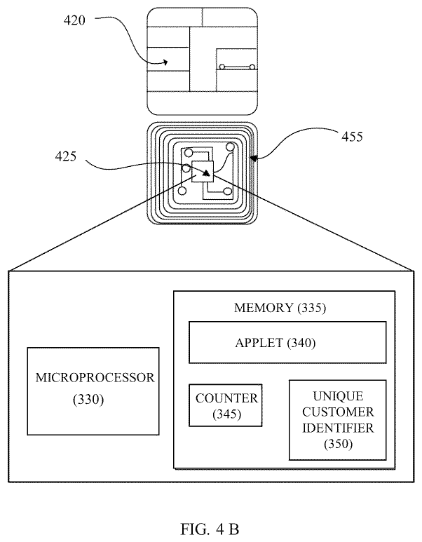

As such, one aspect of the proposed system and method is directed to an authentication scheme involving a uniquely configured contactless card with an integrated NFC tag storing NFC transmittable user authentication data (readable, for example, by a mobile device with a reader component and running a corresponding application). The specific structure, configuration and operations of the contactless card, including its integrated processor, memory and NFC functionality and secure method of sensitive information storage as NFC transmittable data, are described with reference to FIGS. 4A and 4B. An exemplary system implementation (200) for context-switching authentication using the aforementioned contactless card is shown in FIG. 2.

FIG. 2 illustrates an exemplary system (200) for implementing an automated transfer of encrypted user data supplemented with an authentication scheme implemented by on context-switching between a web session (103) and a contactless card (201). The described context-switching authentication scheme enables a single authentication action, involving the contactless card (201) to provide a valid authentication confirmation signal (118) for authorizing the transfer of sensitive user information (e.g., via response message 119) to a (requesting) remote web server (120). FIG. 2 may reference same or similar components and operations as explained above with respect to FIG. 1

The exemplary context-switching authentication implementation (200), illustrated in FIG. 2, utilizes a contactless card (201) having a symmetrically encrypted NFC channel (203) to the user mobile device (110) for the encrypted transmission of user authentication data 202 (stored on the contactless card (201) as NDEF data). The user authentication data (202) retrieved via encrypted NFC transmission (202) from the contactless card (201), may be provided to the authentication application (104) running on the user mobile device (110). The encrypted NFC channel (203), may be activated, for example, when a reader (124) of the user mobile device (110) moves into NFC proximity of the contactless card (201), and/or vice versa. The encrypted authentication data (202) received by the authentication application (104) may be decrypted using a symmetric key shared between the contactless card (201) and a corresponding reader application (e.g., authentication application 104) running on the user mobile device (101). The authentication data may then be transmitted, for validation, to a corresponding authentication application/process (115) running on the authentication server (110). Upon validation (represented by a validation signal (118) from authentication application (115) to data collection process 114 running on authentication server 110), the sensitive user information may be provided (e.g., via response message 119 transmitted across encrypted back-end communication channel 130) to the (requesting) remote merchant server (120) to, for example, facilitate a user payment transaction.

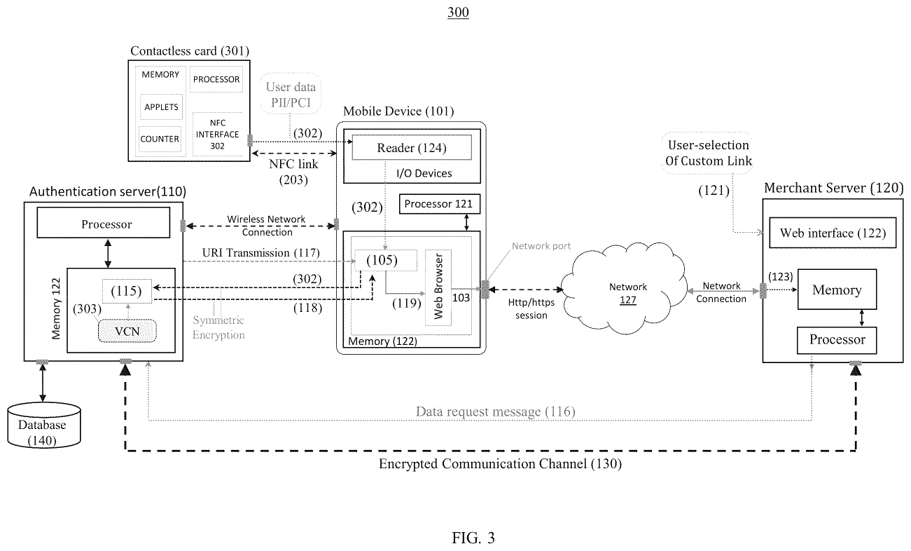

One aspect of the present disclosure is directed to an automated transfer of sensitive user data directly from the contactless card as illustrated by exemplary embodiment (300) in FIG. 3. The automated data transfer process corresponding to a secure transmission of user information directly from the contactless card (301) to a remote merchant server (120) may be facilitated by context-switching between a user web session (103) and a NFC reader functionality provided for example, by application/process (105) running on the mobile device.

FIG. 3 may reference same or similar components as explained above with respect to FIG. 1 and FIG. 2. In the exemplary embodiment (300), the configuration involving the contactless card (301) and user mobile device (101) may be utilized for implementing a direct transfer of user PII and/or PCI data, from the contactless card, to the remote merchant server (120). With reference to the exemplary system implementation (300), the target (mobile) application (105) corresponding to an application identifier coded in the URI transmission 117 (e.g., universal link 117) to the mobile device (101) may be automatically invoked on the mobile device (101) upon reception of the universal link transmission (117) by the user mobile device. In the exemplary embodiment (300), the target application (105) may correspond to an NFC reader application for activating a reader function of the mobile device (e.g., rendering the user device to simply act a reader) to enable the collection (e.g., via a NFC tap of the contactless card onto the user mobile device) of sensitive user information 302 (e.g., user PII and/or PCI data) directly stored onto the contactless card (301). In this way the user PII and/or PCI required to be populated onto a payment checkout or account registration screen may be directly retrieved via an NFC tap from a contactless card (301) storing NFC transmittable user PII and/or PCI information (302). The user information received by the mobile application (105) via NFC transmission from the contactless card (301) may then be transmitted to an authentication process/application (115) on the authentication server (110) for validation (e.g., verifying that user data retrieved from the card (301) matches the initial user identifying data (4) incorporated in the data request message (116).

In accordance to some embodiments, transmission of user data (302) from the contactless card (301) to a receiving application/process (105) on the mobile user device (101) maybe facilitated across a symmetrically encrypted NFC link (203). The symmetric encryption may be associated with a common private cryptographic key shared between the contactless card (301), the target application (105) and authentication application 115 on the authentication server (110). The user-data (302) retrieved by the mobile (target) application (105) via a direct NFC read of the card (301) by a reader component (124) of the mobile device (101), may then be decrypted using the shared private key, and validated by the authentication application (115) based on a correct match with the initial user identifying data (4) in the data request message (116). Upon successful validation, an authentication confirmation signal (118) may be sent to the mobile application (105) to trigger a response message (119) comprising the requested user data which may be transmitted across an encrypted network connection to a remote web server (120) to, for example, facilitate an online payment transaction. In some embodiment the response message (119) may be directly generated by the mobile application in response to the confirmation authentication signal (118) from the authentication server (110). The response message (119) may be transmitted, by the mobile application (105), to the remote merchant server across the encrypted communication channel (130) associated with a back-end integration of the merchant server/system (120) with the system implementation (300). In accordance to some embodiments, the response message (119) maybe encrypted with a public key of a destination merchant system (120) and transmitted to the remote merchant server (120) via the web session (103). This corresponds to data transfer (123) facilitated through web session 103 across pubic network 127, as illustrated in FIG. 3. The user data may then be auto-populated on the web interface (122) of the merchant website/webserver (120). In some embodiments a VCN generating process (303) running, for example, on the authentication server (110) may be invoked in response to the data request message (116) from a remote merchant system (120). Consequently a merchant-specific VCN may be generated and transmitted along with the authentication confirmation signal (118) to the mobile application (105) to be provided, along with user PII data, to the remote merchant system (120).

FIGS. 4A and 4B illustrate an exemplary contactless card 400. Although FIG. 4A and FIG. 4B illustrate single instances of components of card 400, any number of components may be utilized.

Card 400 may be configured to communicate with one or more components of system 100. Card 400 may comprise a contact-based card (e.g., a card read by a swipe of a magnetic stripe or by insertion into a chip reader) or a contactless card, and the card 400 may comprise a payment card, such as a credit card, debit card, or gift card. As shown in FIG. 4A, the card 400 may be issued by a service provider designation 405 displayed on the front of the card 400 (and/or on the back of the card 400). In some examples, the payment card may comprise a dual interface contactless payment card. In some examples, the card 400 is not related to a payment card, and may comprise, without limitation, an identification card, a membership card, and a transportation card.

Card 400 may comprise a substrate 410, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the card 400 may have physical characteristics compliant with the ID-1 format of the ISO/IEC 7810 standard, and the card 400 may otherwise be compliant with the ISO/IEC 14443 standard. However, it is understood that the card 400 according to the present disclosure may have different characteristics, and the present disclosure does not require implementation in a payment card.

The card 400 may also include identification information 415 displayed on the front and/or back of the card, and the card 400 may also include a contact pad 420. The contact pad 420 may be configured to establish contact with another communication device, including but not limited to a user device, smartphone, laptop, desktop, or tablet computer. The card 400 may also include processing circuitry, antenna and other components not shown in FIG. 4A. These components may be located behind the contact pad 420 or elsewhere on the substrate 410.

The service provider designation 405 may include the name and logo of the service provider, and may also include information relating to the service provider, including without limitation a telephone number, address, instructions for handling the card 400 if has been lost or damaged, and other information. The service provider designation 405 may also include an image or graphical design.

The identification information 415 may include, without limitation, an account number, a name, an expiration date, a phone number, a nickname, and other information. In some examples, the identification information 415 may further include an image or graphical design. For example, the identification information 415 may include an image of the user, a picture, a drawing, or a logo.

As illustrated in FIG. 4B, the contact pad 420 of FIG. 4A may include processing circuitry 425 for storing and processing information, including a processor 430, such as a microprocessor, and a memory 435. It is understood that the processing circuitry 425 may contain additional components, including processors, memories, error and parity/CRC checkers, data encoders, anticollision algorithms, controllers, command decoders, security primitives and tamper-proofing hardware, as necessary to perform the functions described herein.

The memory 435 may be a read-only memory, write-once read-multiple memory or read/write memory, e.g., RAM, ROM, and EEPROM, and the card 400 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 435 may be configured to store one or more applets 440, one or more counters 445, and a customer identifier 450. The one or more applets 440 may comprise one or more software applications configured to execute on one or more contact-based or contactless cards, such as Java Card applet. However, it is understood that applets 440 are not limited to Java Card applets, and instead may be any software application operable on contact-based or contactless cards or other devices having limited memory. The one or more counters 445 may comprise a numeric counter sufficient to store an integer. The customer identifier 450 may comprise a unique alphanumeric identifier assigned to a user of the card 400, and the identifier may distinguish the user of the contactless card from other contactless card users. In some examples, the customer identifier 450 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the contact pad 420 or entirely separate from it, or as further elements in addition to processor 430 and memory 435 elements located within the contact pad 420.

In some examples, the card 400 may comprise one or more antennas 455. The one or more antennas 455 may be placed within the card 400 and around the processing circuitry 425 of the contact pad 420. For example, the one or more antennas 455 may be integral with the processing circuitry 425 and the one or more antennas 455 may be used with an external booster coil. As another example, the one or more antennas 455 may be external to the contact pad 420 and the processing circuitry 425.

In an embodiment, the coil of card 400 may act as the secondary of an air core transformer. The terminal may communicate with the card 400 by cutting power or amplitude modulation. The card 400 may infer the data transmitted from the terminal using the gaps in the card's power connection, which may be functionally maintained through one or more capacitors. The card 400 may communicate back by switching a load on the card's coil or load modulation. Load modulation may be detected in the terminal's coil through interference.

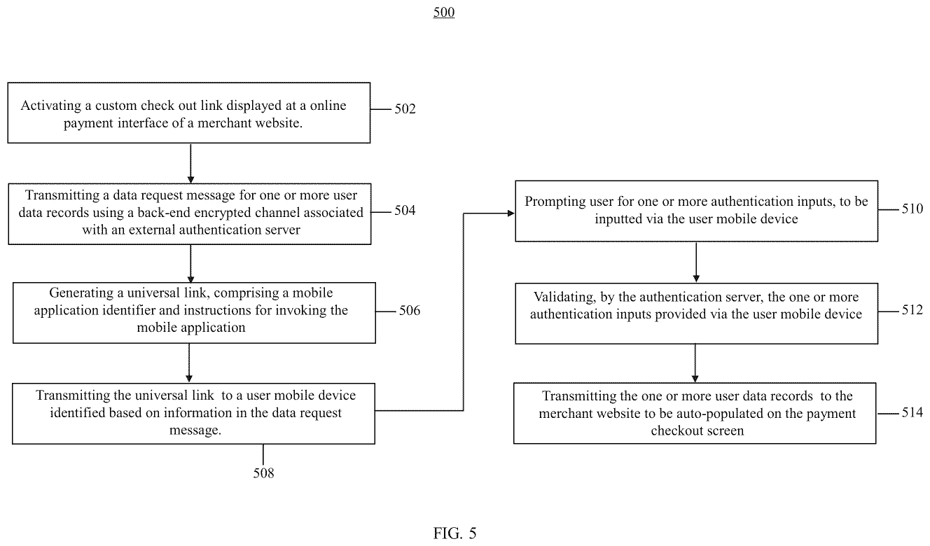

FIG. 5 provides an operational overview of a context-switching authentication process in accordance to some embodiments of the present disclosure. Referring to FIG. 5, the process may be initiated at (502) by an activation of custom (check out) link presented at an online payment interface of a merchant website. The custom link may be associated with a back-end processing option provided via an external authentication system. Responsive to a user selection of the custom link at the online payment interface of the merchant website, the process 500 may move onto step (504) for generating and transmitting a data request message via a back-end encrypted channel, to the external authentication system for processing. The data request message may comprise a request for user PII and/or PCI data, as well as components for identifying the merchant website and the specific user transaction session associated with the selection of the custom link.

An authentication server associated with the external authentication system may receive an incoming data request message across a designated encryption channel associated with the back-end integration of the merchant website. At (506) the authentication server may locate, based on information included in the data request message, a device identifier associated with user mobile device, and generate a universal link, encoding an identifiers to a target application, stored on the user mobile device. The universal link may include additional information such as information included in the data request message, as well as instructions for invoking the target mobile application, which may correspond to a mobile authentication application.

At (508) the universal link is transmitted to a user mobile device associated with the device identifier that may be included in the data request message. At (510) the user is prompted, via the mobile authentication application, for one or more authentication inputs to be inputted using the mobile device. At (512), the one or more authentication input, provided via the user mobile device are validated by the authentication server and at (514) the requested user PI and/or PCI data is transmitted to the merchant website via the back-end encrypted channel—and subsequently applied to the specific user transaction session (e.g., auto-populated on the online payment interface displaying the custom link).

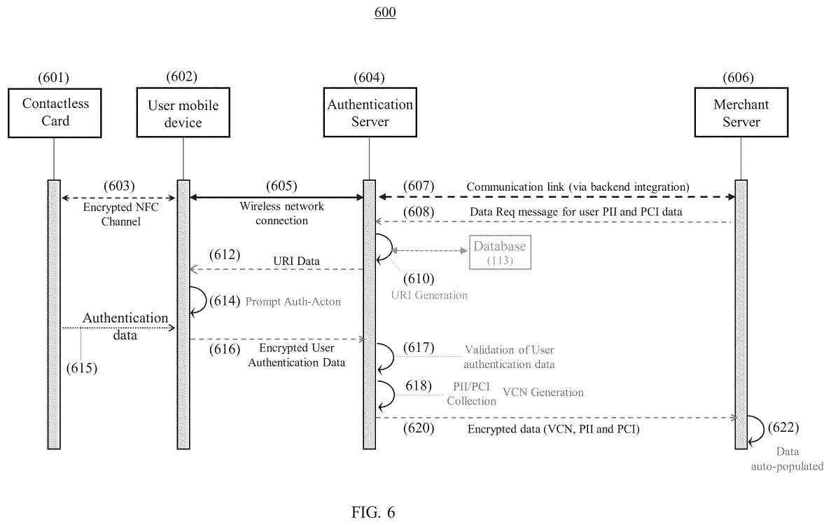

FIG. 6 illustrate an exemplary sequence diagram (600) pertaining to an automated process for secure retrieval of sensitive user information, validated based on one or more user authentication data securely stored, as NFC transmittable data, on an integrated memory of a contactless card (601) and retrieved, by user mobile device (602) via an encrypted NFC channel (603) established between the contactless card (601) and the user mobile device (602). The information may then be transmitted to an authentication server (604), via a wireless network connection (605) for validation. Upon validation, the sensitive user information may be provided to a requesting merchant server (606) via an encrypted back-end communication channel (607) (e.g., implemented via a back-end integration of the merchant server (606) with the authentication and encryption providing system and process.)

The process may be initiated in response to a data request message (608) pertaining to sensitive user information required for facilitating a specific user transaction. The data request message (608) being generated by the merchant server (606) in response to an activation of a custom link presented at a web interface of merchant server 606, and transmitted to the authentication server (604). Data request message (608) may further comprise an anonymous unique user session identifier, a merchant website/webserver identifier, and an initial user identifying information. The authentication server, in response to the data request message (608) may generated a URI (e.g., universal link) a transmit the URI (612) to the user mobile device (602).

The URI may comprise encoded instruction and identifiers for invoking an authentication application stored on the user mobile device. Upon invocation, in accordance to the instructions in the URI, the mobile authentication application may prompt the user to initiate an NFC read of the contactless card (601) via a reader unit of the user mobile device (602). At (615) the user authentication data, stored in NDEF on the contactless card (601), is read by the user mobile device (602), for example, by tapping the contactless card to a reader of the user mobile device to initiate a NFC transmission. authentication server (604) for validation of the user authentication data at (617), the authentication server may retrieve the requested sensitive user information at (618) and, at (620), transmit the requested sensitive user information to the requesting merchant server (606), across the encrypted communication link (607)—in some instances, user PCI data may correspond to a Primary account number which may be provided to a requesting merchant server, via the encrypted communication channel (607) as part of the information requested. However, in some embodiments the operation (618) pertaining to the retrieval of sensitive user information (e.g., collection of user PII data) may also involve generation of a merchant-specific Virtual Credit Card Number (VCN) mapped to user primary account, which may be provided as a substitute for user PAN in the transmission (620). At (622), the received (sensitive) user information is auto is auto-populated on the appropriate transaction form provided by the merchant server (606).

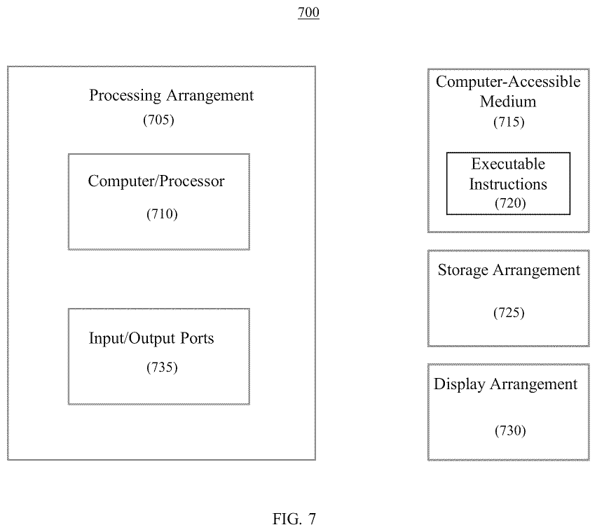

FIG. 7 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) 705. Such processing arrangement and/or computing arrangement 705 can be, for example entirely or a part of, or include, but not limited to, a computer/processor 710 that can include, for example one or more microprocessors, and use instructions stored on a computer-accessible medium (e.g., RAM, ROM, hard drive, or other storage device).

As shown in FIG. 7, for example a computer-accessible medium 715 (e.g., as described herein above, a storage device such as a hard disk, floppy disk, memory stick, CD-ROM, RAM, ROM, etc., or a collection thereof) can be provided (e.g., in communication with the processing arrangement 705). The computer-accessible medium 715 can contain executable instructions 720 thereon. In addition or alternatively, a storage arrangement 725 can be provided separately from the computer-accessible medium 715, which can provide the instructions to the processing arrangement 705 so as to configure the processing arrangement to execute the exemplary procedures, processes, and methods, as described herein above, for example.

Further, the exemplary processing arrangement 705 can be provided with or include an input/output ports 735, which can include, for example a wired network, a wireless network, the internet, an intranet, a data collection probe, a sensor, etc. As shown in FIG. 7, the exemplary processing arrangement 705 can be in communication with an exemplary display arrangement 730, which, according to certain exemplary embodiments of the present disclosure, can be a touch-screen configured for inputting information to the processing arrangement in addition to outputting information from the processing arrangement, for example. Further, the exemplary display arrangement 730 and/or a storage arrangement 725 can be used to display and/or store data in a user-accessible format and/or user-readable format.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

Systems and methods described herein can provide secure, retrieval of sensitive user information or enabling streamlined communication and processing of sensitive user information for example, for facilitating secure electronic transactions. Once a valid authorization response from an authenticated user has been established, the automated data retrieval and transfer system and process can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions.

As used herein, personal identification information (PII) can include any sensitive data, including financial data (e.g., account information, account balances, account activity), personal information and/or personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for facilitating an automated transfer of authenticated user information based on context-switching authentication, the method comprising:
providing a custom link at an interface of a website, wherein the website is integrated with an authentication functionality provided by an external authentication system;
generating, in response to a user selection of the custom link, a universal link, wherein the universal link comprises:
a website identifier identifying the website where the custom link is activated by the user selection,
a unique anonymous user identifier, the unique anonymous user identifier generated by the website to track a particular user session, and
an identifier for a authentication application associated with the external authentication system, wherein the authentication application is stored on a user device from which the website is accessed;
transmitting the universal link to the user device, wherein the universal link is configured to launch the authentication application prompting the user for an authentication action, the authentication action comprising bringing, within near field communication (NFC) range of the user device, a contactless card with an NFC tag storing one or more user identity and payment credential information as NFC transmittable data;
transmitting the one or more user identity and credential information, retrieved via an NFC from the contactless card, to be auto-populated on the interface of the website.

2. The method of claim 1, wherein the universal link comprises an identifier for a data-collection application with a deep link to the authentication functionality provided by the external authentication system, wherein the authentication functionality is integrated in the data-collection application.

3. The method of claim 2, wherein the authentication functionality is provided by a authentication application stored on the user device and operationally coupled with the data-collection application.

4. The method of claim 2, wherein the user identity and credential information is collected by the data-collection application and transmitted to a requesting website upon verifying user authenticating information retrieved via NFC from the contactless card.

5. The method of claim 1, wherein the website identifier and the unique anonymous user identifier information in the universal link are used to identify the particular user session associated with the authentication action.

6. The method of claim 1, wherein the authentication action further comprise at least one selected from the group of inputting login credentials into the authentication application and confirming identity by inputting a temporary one time password sent as at least one selected from the group of text and voice to the user device.

7. The method of claim 1, wherein the user identity and credential information transmitted via NFC from the contactless card to the authentication application on the user device are encrypted with a symmetric encryption.

8. The method of claim 7, wherein the one or more user identity and credential information transmitted by the user device to the website are encrypted using a public key encryption process, wherein the user identity and credentials information are decrypted prior to auto-populating the interface of the website.

9. The method of claim 1, wherein the universal link is coded to re-direct the user to an application store for downloading the authentication application if the authentication application is not installed on the user device.

10. An authentication system for implementing an automated retrieval of authenticated user information based on context-switching authentication, the system comprising:
a link generating server communicatively coupled to one or more web servers via a network, the link generating computer configure to:
display a custom link at an interface of a website associated with each of the one or more web servers, wherein the website is integrated with an authentication functionality provided by the authentication system;
generate, in response to a user selection of the custom link, a universal link, wherein the universal link comprises:
a website identifier identifying the website where the custom link is activated by the user selection,
a unique anonymous user identifier, the unique anonymous user identifier generated by the website to track a particular user session, and
an identifier for an authentication application associated with the authentication system, wherein the authentication application is stored on a user device from which the website is accessed;
transmit the universal link to the user device, the universal link launching the authentication application to prompt the user for an authentication action, the authentication action comprising bringing, within near field communication (NFC) range of the user device, a contactless card with an NFC tag storing one or more user identity and credential information as NFC transmittable data;
transmit, by the authentication application running on the user device, the one or more user identity and credential information, retrieved via an NFC transmission from the contactless card, to be auto-populated on the interface of the website.

11. The authentication system of claim 10, wherein the universal link is configured with an identifier for a data-collection application with a deep link to the authentication functionality provided by the authentication system, wherein the authentication functionality is integrated in the data-collection application.

12. The authentication system of claim 11, wherein the authentication functionality is provided by the authentication application stored on the user device and operationally coupled with the data-collection application.

14. The authentication system of claim 11, wherein the system is configured to collect user identity and credential information using the data-collection application and authenticate the transfer of the user identity and payment credential information to the website based on a verification of user authenticating information retrieved via the NFC transmission from the contactless card.

15. The authentication system of claim 10 wherein the authentication system is configured to identify the particular user session associated with the authentication action based on the website identifier and the unique anonymous user identifier information in the universal link.

16. The authentication system of claim 10, wherein the authentication system is further configured for one or more authentication actions comprising one or more of: inputting login credentials into the authentication application and confirming identity by inputting a temporary one time password sent as one of a text message, voice message and a pop-up notification, to the user device.

17. The authentication system of claim 10, wherein the authentication system is further configured to encrypt, using a symmetric encryption scheme, the user identity and credential information transmitted via NFC from the contactless card.

18. The authentication system of claim 10, wherein the authentication system is further configured to encrypt, using a public key encryption scheme, the user identity and credential information transmitted to the website where the custom link is activated by the user selection.

19. A non-transitory computer-readable medium comprising instructions for execution by a computer hardware arrangement, wherein, upon execution of the instructions the computer hardware arrangement is configured to perform procedures comprising:
displaying a custom link at an interface of a website, wherein the website is integrated with an authentication functionality provided by an external authentication system;
generating, in response to a user selection of the custom link, a universal link, the universal link comprising:
a website identifier identifying the website where the custom link is activated by the user selection;
a unique anonymous user identifier, the unique anonymous user identifier being generated by the website to track a particular user session;
an identifier for a authentication application associated with the external authentication system, wherein the authentication application is stored on a user device from which the website is accessed;
transmitting the universal link to the user device, wherein the universal link launches the authentication application prompting the user for an authentication action, the authentication action comprising bringing, within near field communication (NFC) range of the user device, a contactless card with an NFC tag storing one or more user identity and credential information as NFC transmittable data;
transmitting, by the user device, the one or more user identity and credential information, retrieved via an NFC transmission from the contactless card, to be auto-populated on the interface of the website where the custom link is activated by the user selection.

20. The non-transitory computer-readable medium of claim 19, wherein, the non-transitory computer-readable medium further comprises instructions for encrypting, using a symmetric encryption scheme, the user identity and payment credential information transmitted, via NFC from the contactless card, to the authentication application on the user device with a symmetric encryption.
